(19) United States
(12) Patent Application Publication
(10) Pub. No.: US 2023/0095945 A1
(43) Pub. Date: Mar. 30, 2023

(54) Brake Caliper Support, Disc Brake Assembly, Use of a Brake Caliper Support, and Method for Guiding Air

(71) Applicant: MANN+HUMMEL GmbH, Ludwigsburg (DE)

(72) Inventors: Benedikt WELLER, Kleinbottwar (DE); Tobias WÖRZ, Leutenbach (DE); Lukas BOCK, Bietigheim-Bissingen (DE); Steffen PFANNKUCH, Ludwigsburg (DE)

(21) Appl. No.: 18/075,432

(22) Filed: Dec. 6, 2022

Related U.S. Application Data
(63) Continuation of application No. PCT/EP2021/066483, filed on Jun. 17, 2021.

(30) Foreign Application Priority Data
Jul. 16, 2020 (DE) 10 2020 118 880.3

(51) Int. Cl. F16D 65/00

(52) U.S. Cl. CPC F16D 65/0031; F16D 2055/0008

(57) ABSTRACT

A brake caliper support for a brake caliper of a disc brake assembly with a brake disc has a brake caliper support bracket provided with at least two fastening sections for connecting the brake caliper support to a steering knuckle of a vehicle. The brake caliper support bracket in a mounted state at the vehicle is positioned opposite a brake disc friction surface of the brake disc. A brake caliper support bridge projects away from the brake caliper support bracket in axial direction of the brake disc and circumferentially surrounds the brake disc at least partially in the mounted state. An arc-shaped air guiding element is disposed at the brake caliper support bracket. The air guiding element is positioned axially opposite the brake disc friction surface of the brake disc in the mounted state. The air guiding element is a protrusion or a recess extending axially, respectively.

### CROSS-REFERENCE TO RELATED APPLICATIONS

This application is a continuation application of International Application No. PCT/EP2021/066483 filed on Jun. 17, 2021, which claims the benefit of German Application No. 10 2020 118 880.3 filed on Jul. 16, 2020, the entire disclosures of which are incorporated herein by reference for all purposes.

### BACKGROUND

Embodiments concern a brake caliper support for a disc brake assembly, in particular for a motor vehicle. Furthermore, such a disc brake assembly is proposed. Moreover, use of the brake caliper support as well as a method for guiding air with a brake caliper support is proposed.

The configuration of a disc brake assembly with a brake disc, a brake caliper holder, and a brake caliper is known to a person of skill in the art. The brake caliper holder connects the brake caliper to a component fixed at the vehicle, for example, a steering knuckle, and serves for dissipating braking forces that are guided during the braking process from the brake pad through the brake caliper holder into the component fixed at the vehicle. The brake caliper itself does not participate in the force flow during the braking process but serves only for generating an axially oriented pressing force on the brake pads.

During a braking process, particles are produced due to abrasion at a brake disc and/or at brake pads. In order to retain these particles, for example, a brake dust particle filter is employed which is arranged downstream of a brake caliper device for a forward rotation direction.

Such a brake dust particle filter is known, for example, from WO 2019/048374 A1. The brake dust particle filter described therein is arranged downstream of the brake caliper support in a rotation direction.

### SUMMARY

It is an object of the embodiments to achieve a flow optimization in the region of the brake caliper or brake caliper support by means of which an improved reduction of brake dust emissions at the disc brake assemblies results, in particular in combination with a brake dust particle filter.

According to a first embodiment, a brake caliper support for holding a brake caliper of a disc brake assembly with a brake disc in a vehicle is proposed. The brake caliper support comprises:

a first brake caliper support bracket with at least two fastening sections for vehicle-side connection of the brake caliper support to a steering knuckle of the vehicle, wherein the first brake caliper support bracket in the mounted state is positioned opposite a brake disc friction surface of the brake disc;

a brake caliper support bridge which projects away from the first brake caliper support bracket in axial direction and at least partially circumferentially surrounds the brake disc in the mounted state; and

an arc-shaped air guiding element which is present at the first brake caliper support bracket and is positioned axially opposite the brake disc friction surface of the brake disc in the mounted state;

wherein the air guiding element is formed in axial direction in the manner of a protrusion or in the manner of a recess.

Herein, “positioned opposite” is understood as a mutual axial arrangement of the arc-shaped air guiding element and of the brake disc friction surface of the brake disc, wherein this feature however is intended to also expressly encompass embodiments in which the arc-shaped air guiding element is present radially beyond the actual friction surface and in particular is arranged radially inwardly displaced in relation to the friction surface.

The air guiding element can guide the brake dust particle-laden air which is produced during the braking process in such a way in circumferential direction of the brake disc that it is prevented that the air exits from the disc brake assembly in radial direction.

In particular, the air guiding element can guide the air in such a way that the air flow entering a brake dust particle filter arranged downstream of the brake caliper support is optimally oriented in order to be able to separate in this way a quantity of brake dust particles as large as possible.

In general, a larger quantity of particles can be guided into the brake dust particle filter arranged downstream of the disc brake assembly in forward rotation direction and can be separated thereat. In this way, a reduction of brake dust emissions at the disc brake assembly can be achieved.

The brake caliper support in the mounted state can be fastened stationarily at the vehicle or at a vehicle wheel, in particular at the steering knuckle. The steering knuckle is in particular a wheel support which is preferably pivotable. An attachment of the brake caliper support at the vehicle or vehicle wheel can be realized by means of the fastening sections. The fastening sections are configured in this context e.g. as openings through which bolts can be passed for connection to the steering knuckle.

The brake caliper support and the brake caliper can be part of the disc brake assembly. The brake caliper is in particular floatingly supported at the brake caliper support. This floating support enables an axial movement of the brake caliper relative to the brake caliper support and thus to the vehicle. The floating support is achieved in particular by pistons or pins which movably hold the brake caliper at the brake caliper support. The brake caliper comprises preferably at least one brake pad. In the mounted state, the brake caliper support can “frame” the brake caliper.

During a braking process, brake fluid is pressurized and forces by means of a piston of the brake caliper the brake pad of the brake caliper against the brake disc. In this way, a rotation of the brake disc can be slowed and/or stopped.

The first brake caliper support bracket is in particular a section of the brake caliper support that comprises the fastening sections. In the mounted state, the first brake caliper support bracket extends in particular in such a way that it is positioned in parallel opposite the brake disc friction surface.

The brake caliper support bridge extends in particular at an angle to the first brake caliper support bracket. The brake caliper support bridge is projecting, for example, axially away from a radially extending section of the first brake caliper support bracket. That the brake caliper support bridge at least partially circumferentially surrounds the brake disc means in particular that the brake caliper support bridge is positioned opposite a circumferential edge of the brake disc. The brake caliper support bridge and the first brake caliper support bracket can be designed as one piece.

The terms “radial”, “axial”, and “tangential” relate in particular to an orientation in the mounted state (also “mounting state”) in which the brake caliper support is mounted at the steering knuckle. In this case, the orientations “radial”, “axial”, and “tangential” are to be understood in relation to the brake disc, i.e., to the rotation axis of the brake disc. In the unmounted state, “radial”, “axial”, and “tangential” refer to three orientations which differ from each other. Tangential means in particular along the circumferential direction.

The air guiding element is of an arc-shaped configuration. This means in particular that at least one section of the air guiding element does not extend straight. Arc-shaped can also be understood as curved. The air guiding element can extend e.g. along a circular segment section.

The air guiding element can be provided at a surface of the first brake caliper support bracket which is positioned opposite the brake disc in the mounted state. The air guiding element can be embodied as one piece together with the first brake caliper support bracket. When the air guiding element is configured as a protrusion, an axial distance (in the mounted state) between the first brake caliper support bracket and the brake disc can be reduced in the region of the air guiding element. When the air guiding element is embodied as a recess (also “cutout”), an axial distance (in the mounted state) between the first brake caliper support bracket and the brake disc can be increased in the region of the air guiding element.

According to an embodiment, the first brake caliper support bracket comprises a connection section which extends between the two fastening sections as well as a lateral section that connects the connection section to the brake caliper support bridge and extends with a radial orientation component in the mounted state.

The connection section can extend along the tangential direction. The lateral section can be provided at an angle to the connection section. The lateral section extends in particular along the radial direction.

According to a further embodiment, the brake caliper support comprises moreover a second brake caliper support bracket which is positioned opposite the first brake caliper support bracket, wherein the brake caliper support is suitable for receiving the brake disc between the first brake caliper support bracket and the second brake caliper support bracket in the mounted state, and wherein the brake caliper support bridge connects the first and the second brake caliper support bracket to each other.

The brake caliper support can comprise a second brake caliper support bracket which is configured similar to the first brake caliper support bracket and, in the mounted state, is arranged at the other side of the brake disc than the first brake caliper support bracket. It is possible to provide one or a plurality of brake caliper support bridges which connect the brake caliper support brackets to each other.

According to a further embodiment, the air guiding element is arranged at the connection section and/or at the lateral section, wherein the air guiding element extends in particular along an extension direction of the connection section, preferably tangentially, and/or of the lateral section, preferably radially.

That the air guiding element extends along the extension direction of the connection section and/or of the lateral section means in particular that an extension direction of the air guiding element coincides with the extension direction of the connection section and/or of the lateral section.

According to a further embodiment, the air guiding element comprises a rib, which is protruding away from the connection section or away from the lateral section, or a channel-shaped groove in the connection section or in the lateral section.

The rib can be viewed as an example of a protrusion. The rib serves in particular for sealing as well as for guiding the flow. The groove can be an example of the recess. The channel-shaped groove can extend along the flow direction. The groove serves preferably for guiding the flow.

According to a further embodiment, the air guiding element of the connection section comprises a protruding rib and/or the air guiding element of the lateral section comprises a channel-type groove.

Fluidically, it has been found to be particularly advantageous when the air guiding element of the connection section is embodied as a protruding rib and the air guiding element of the lateral section as a channel-shaped groove.

According to a further embodiment, the protrusion is a protrusion away from a surface of the first brake caliper support bracket or the recess is a recess in a surface of the first brake caliper support bracket.

In particular, the protrusion or recess is not provided on a rim of the brake caliper support bracket but in an areal section of the first brake caliper support bracket.

According to a further embodiment, the air guiding element is configured as a protrusion and is arranged axially at a circumferential edge of the first brake caliper support bracket.

The air guiding element is arranged, for example, along the circumferential edge of the first brake caliper support bracket. In this context, the circumferential edge of the first brake caliper support bracket can be an edge of the connection section which is farthest removed from the brake caliper support bridge.

According to a further embodiment, the air guiding element is formed as a protrusion and is fastened detachably at the first brake caliper support bracket, in particular by means of a screw connection and/or a clamping connection.

Providing the air guiding element so as to be detachable is particularly advantageous because in this way retrofitting of a brake caliper support which originally does not comprise an air guiding element is enabled.

According to a further embodiment, the brake caliper support is of a one-piece configuration, in particular a single cast part, wherein the air guiding element is present as one piece together with the brake caliper support.

In particular, one-piece means a one-part component. The air guiding element can be cast integrally with the first brake caliper support bracket.

According to a further embodiment, the air guiding element extends as one piece along the connection section and the lateral section, and the air guiding element comprises a bend.

The bend in the air guiding element refers in particular to a change of the extension direction of the air guiding element. The bend is located, for example, at the boundary between the connection section and the lateral section. Due to this angled course, a deflection of the air flow into the brake dust particle filter can be optimized.

According to a further embodiment, the air guiding element comprises a first section which extends tangentially in the mounted state and comprises an indirectly or directly adjoining second section which is bent radially outwardly in the mounted state, wherein preferably the air guiding element comprises a third section between the first section and the second section which forms a radially inwardly oriented bulge.

Due to this angled course and optionally due to the bulge, a deflection of the air flow into the brake dust particle filter can be optimized. This embodiment is in particular advantageous in connection with the internally vented brake disc described in the following.

According to a further embodiment, the air guiding element extends continuously from one fastening section to the other fastening section along the connection section.

In other words, the air guiding element can extend along a total (in particular tangential) extension direction of the connection section. In other embodiments, the air guiding element extends only along a section (for example, along half) of the connection section. The section of the connection section along which the air guiding element extends is in particular at the side of the brake caliper support which borders the brake dust particle filter.

According to a further embodiment, the lateral section, in relation to the mounted state, comprises an inner edge and an outer edge in circumferential direction wherein the air guiding element extends continuously from the inner edge all the way to the outer edge.

According to a second aspect, a disc brake assembly with a brake disc and the brake caliper support according to the first aspect or according to an embodiment of the first aspect is proposed, wherein a brake disc friction surface of the brake disc is arranged opposite the air guiding element and the first brake caliper support bracket.

In this context, the brake caliper support and the brake caliper cover at least in sections a friction surface of the brake disc in radial direction along the circumferential direction. One or a plurality of brake pads can be arranged moreover at the brake caliper.

During the braking process, brake dust particles are produced substantially at the friction surface and at the brake pads acting thereon. Therefore, the brake dust particle filter with its filter housing is arranged as close as possible at the brake caliper.

In embodiments, the disc brake assembly is embodied with an internally vented brake disc. An internally vented brake disc comprises a brake disc edge with radial outflow openings. In the interior of the brake disc, air channels for cooling the brake disc extend so that the heated cooling air exits substantially radially at the outflow openings. It can be advantageous to embody the circumferential wall opposite the brake disc edge (for externally vented brake discs) or opposite the radial outflow openings to be air-tight.

The air guiding element deflects the air in particular in the direction of an intake region of the inner venting action. In this way, the particles are in particular not deflected into the environment but reach the brake disc particle filter through the internal venting action of the brake disc. Here, the particles can be separated at the filter medium by the corresponding flow conditions.

According to an embodiment, the air guiding element is configured to deflect brake dust-laden air flowing along the rotating brake disc. Deflection means here in particular that the air guiding element changes a flow direction of the brake dust-laden air.

According to a further embodiment, the air guiding element is suitable to prevent the brake dust-laden air from radially exiting the brake caliper support. In this way, a greater number of particles is deflected into the brake dust particle filter.

According to a further embodiment, the air guiding element is arranged at the connection section and engages at least partially axially in a brake disc bell of the brake disc. In this way, escape of particles radially through a gap between the brake disc bell and the brake caliper support can be reduced.

According to a further embodiment, the disc brake assembly comprises furthermore a brake dust particle filter which, in a predetermined rotation direction of the brake disc, in particular the forward rotation direction, is arranged downstream of the brake caliper support.

In embodiments, a filter housing used for the brake dust particle filter can be a ring segment-shaped, for example, banana-shaped or helmet-shaped, filter housing. The interior of the filter housing is facing the brake disc in this context. It is conceivable to provide in the filter housing a filter medium which is made of a material which can withstand the relatively high temperatures during a disc braking process. The filter medium is suitable to bind or retain the brake dust particles.

In embodiments, the filter medium comprises an areal material with metal fibers, glass fibers, ceramic fibers and/or temperature-resistant plastic materials. Preferably, the employed filter material is resistant at typical operating temperatures of disc brake assemblies, for example, between −20° C. and 700° C. Known are metal fiber nonwovens that can be used as filter material. Tests by the applicant have shown that filter materials which are used in filter assemblies for crankcase venting devices are suitable as filter material in brake dust particle filters.

The filter housing and/or the brake caliper support are preferably also manufactured of a material that is resistant at temperatures between −20° C. and 700° C.

The brake dust particle filter is suitable for arbitrary applications in disc brakes. In this context, the brake dust particle filter can be used for stationary or mobile applications. As mobile applications, for example, motor vehicles such as passenger cars, trucks, buses, rail vehicles or the like are conceivable. Stationary, shaft brakes as they are used in wind or water power plants can be provided with corresponding brake dust particle filters.

The embodiments and features that have been described for the proposed brake caliper support apply likewise to the proposed disc brake assembly.

According to a third aspect, use of the brake caliper support according to the first aspect or according to an embodiment of the first aspect is proposed for targeted guiding by the air guiding element of brake dust-laden air flowing along a rotating brake disc into a brake disc particle filter which is arranged downstream of the brake caliper support in a predetermined rotation direction of the brake disc, in particular the forward rotation direction.

The embodiments and features described for the proposed brake caliper support and the disc brake assembly apply likewise to the proposed use.

According to a fourth aspect, a method for guiding brake-dust laden air flowing along a rotating brake disc is proposed with a brake caliper support according to the first aspect or according to an embodiment of the first aspect which holds the brake caliper of the brake disc. The method comprises:

deflecting the brake dust-laden air by the air guiding element of the brake caliper support; and

guiding the deflected air along a forward rotation direction of the brake disc so that it exits through an exit region from the brake caliper support, wherein the exit region is arranged downstream of the lateral section and/or of the connection section of the brake caliper support, in a predetermined rotation direction of the brake disc, in particular in the forward rotation direction.

According to an embodiment, the method comprises moreover:

introducing the air exiting from the exit region into a brake dust particle filter which is arranged downstream of the brake caliper support in the predetermined rotation direction of the brake disc.

The embodiments and features described for the proposed brake caliper support and the disc brake assembly apply likewise to the proposed method.

Further possible implementations comprise also combinations, not explicitly mentioned, of features or embodiments described above or in the following in relation to the embodiments. In this context, a person of skill in the art will also add individual aspects as improvements or supplements to the respective basic form of the embodiments.

Further advantageous embodiments and aspects are subject matter of the dependent claims as well as of the embodiments described in the following. In the following, the embodiments will be explained in more detail with reference to the attached Figures.

### BRIEF DESCRIPTION OF THE DRAWINGS

FIG. 1 shows a perspective view of an embodiment of a disc brake assembly.

FIG. 2 is a lateral plan view of the disc brake assembly according to FIG. 1.

FIG. 3 is a plan view (from above) of the disc brake assembly according to FIG. 1.

FIG. 4 is a plan view (in travel direction) of the disc brake assembly according to FIG. 1.

FIG. 5 is a lateral plan view of an embodiment of a filter housing of a brake dust particle filter for a disc brake assembly according to FIGS. 1-4.

FIG. 6 is a perspective view of the filter housing according to FIG. 5.

FIG. 7 is a lateral plan view of the disc brake assembly according to FIG. 1 without brake dust particle filter.

FIG. 8 is a perspective view of a brake caliper support.

FIG. 9 is a perspective view of a brake caliper device.

FIG. 10 is a perspective view of the brake caliper device according to FIG. 9 with a brake dust particle filter.

FIG. 11 is a perspective view of a further brake caliper device.

FIG. 12 is a section view of the brake caliper device of FIG. 11.

In the Figures, same or functionally the same elements, insofar as nothing to the contrary is indicated, are provided with the same reference characters.

### DETAILED DESCRIPTION

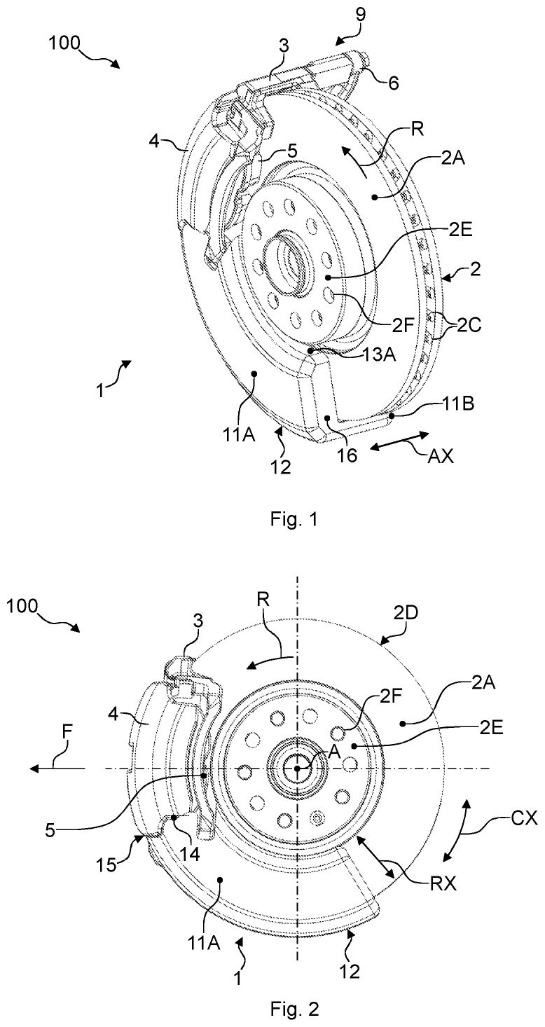

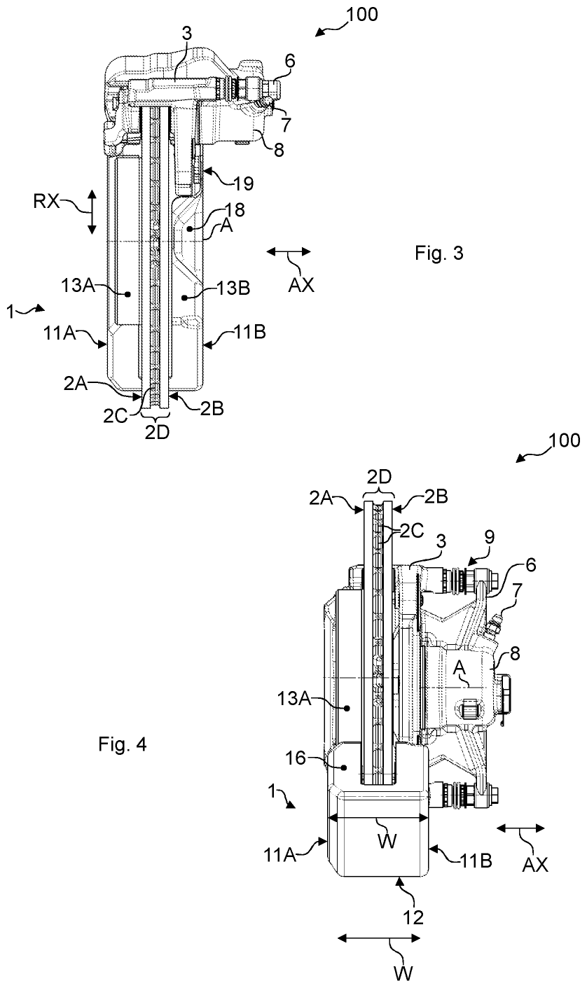

In FIGS. 1, 2, 3, and 4, different views of an embodiment of a disc brake assembly, for example, for a motor vehicle, are illustrated. In this context, a perspective view of the disc brake assembly 100 is illustrated in FIG. 1, a lateral view in FIG. 2, and plan views parallel to the axis of rotation A in FIGS. 3 and 4.

The disc brake assembly 100 comprises a brake disc 2 which is provided with an internal venting action in the illustrated embodiment. The brake disc 2 has a radially inwardly positioned fastening plate 2E comprising fastener openings 2F. In the Figures, only one opening 2F is provided with a reference character, respectively. By means of the fastening plate 2E and the fastener openings 2F, the brake disc 2 is fastened by means of suitable fastener means, such as, for example, wheel bolts, at the wheel suspension so that a rotationally fixed coupling with the vehicle wheel, not illustrated here, or the wheel rims is produced. At the circumferentially extending brake disc edge 2D (compare FIG. 3), one can see radially outwardly oriented outflow openings 2C. In operation of the brake which is rotating in rotation direction R, air for cooling the brake disc 2 flows out of the outflow openings 2C. In the following, a braking process during forward travel is considered for simplification. In principle, the rotation direction can also be reversed.

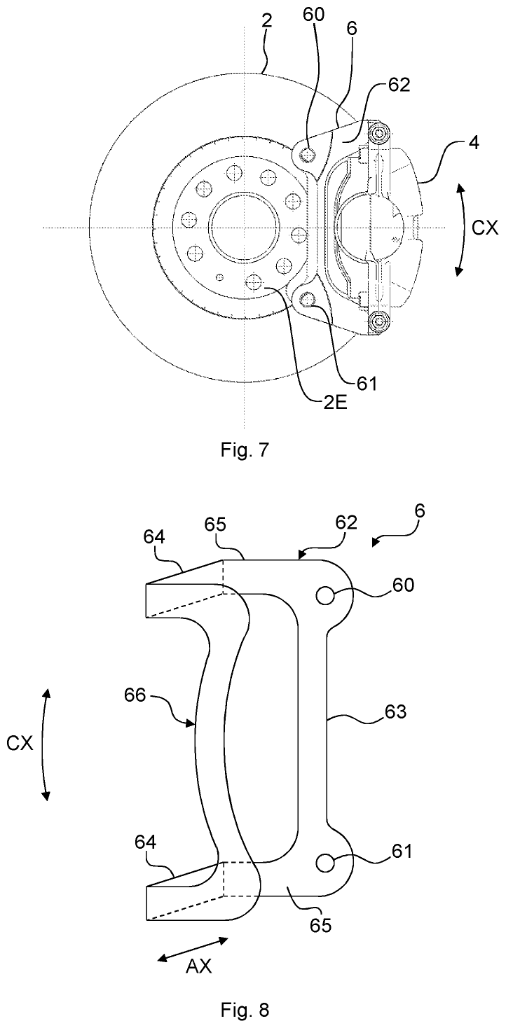

In the Figures, a forward rotation direction R opposite to the clockwise direction is indicated (except in FIG. 7 which shows the brake from the interior of the vehicle). This is referred to in the following as forward rotation direction R. The axis of rotation A can be seen in FIGS. 2, 3, and 4. An axial extension direction AX (compare FIGS. 1, 3, and 4), a radial extension direction RX (compare FIG. 3), and a circumferential extension direction CX (compare FIG. 2) result based on the orientation of the brake disc 2.

In FIG. 2, an installation situation of the brake disc 2 and brake caliper 4 engaging around the brake disc 2 is indicated substantially. The brake caliper 4 is coupled to a brake caliper holder 3 which also engages around the brake disc 2. At both sides of the brake disc 2, brake pads 5 are arranged at the brake caliper 4 and are pressed against the friction surfaces 2A, 2B by means of brake hydraulics 8 (compare FIGS. 3 and 4) during the braking process.

The brake caliper holder 3 as well as the brake caliper 4 are held by a floating support 9 by means of a brake caliper support 6. Due to the floating support 9, an automatic centering of the brake caliper 4 with the brake pads 5 in relation to the brake disc 2, positioned between the gripper arms of the brake caliper 4 or the two brake pads 5, is provided. In the illustrated embodiment, the brake caliper 4 in forward direction F is arranged in front of the axis of rotation A. However, variants are also conceivable in which the brake caliper 4 is arranged behind the axis A.

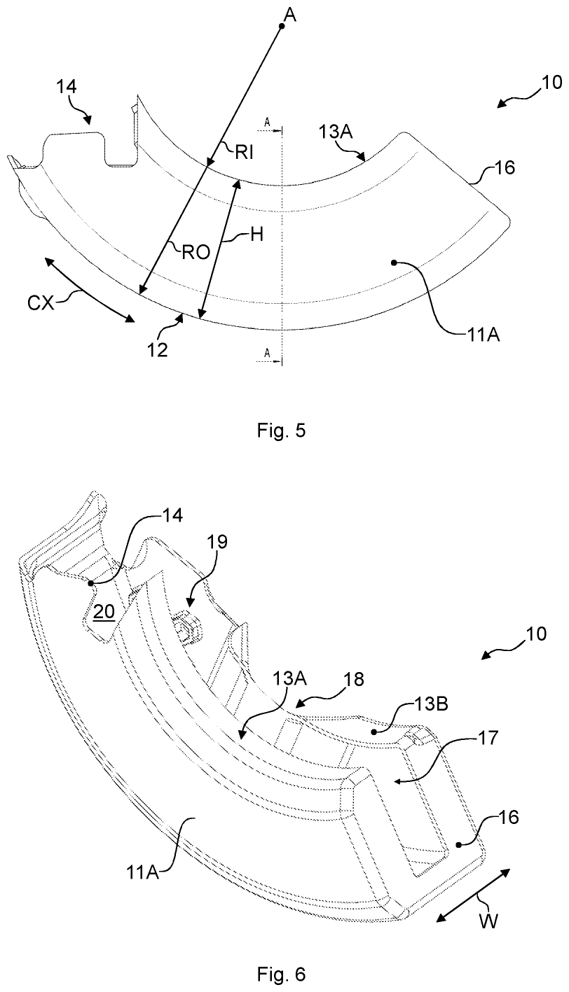

Since the brake pads 5 press against the friction surfaces 2A, 2B of the brake disc 2 during the braking process, abrasion particles are produced at the brake pads 5 and in principle also at the brake disc 2. A portion of these brake dust particles are entrained by the rotation direction R of the brake disc in the circumferential direction CX. Therefore, for catching this brake dust or the brake dust particles, a brake dust particle filter 1 is provided in rotation direction R downstream of the brake caliper 4. Detailed side views and perspective illustrations of the filter housing 10 of the brake dust particle filter 1 are represented in FIGS. 5 and 6.

The housing 10 of the brake dust particle filter 1 engages around a region of the brake disc 2 substantially in a ring segment-shaped form. For this purpose, the brake dust particle filter 1 comprises a housing 10. The housing 10 has two oppositely positioned sidewalls 11A, 11B that are connected to each other by an outer circumferential wall 12 to a substantially U-shaped cross section. In the orientation of FIGS. 1, 3, and 4, an outer sidewall 11A results which is facing away from the vehicle in the mounted state. The oppositely positioned sidewall 11B (in the orientation of FIGS. 3 and 4 at the right side) is referred to as inner sidewall 11B because it is facing the interior of the vehicle. The brake disc 2 is thus partially enclosed between the two sidewalls 11A, 11B.

In radial direction opposite the circumferential wall 12, inner circumferential wall sections 13A, 13B are provided. The outwardly positioned, radially inwardly positioned, and axially outwardly positioned circumferential wall section is identified by 13A. The radially inwardly positioned and axially inwardly positioned circumferential section is identified by 13B.

Toward the brake caliper 4, the filter housing 10 has an edge with a connection contour 14 so that a gap 15 is present between the brake caliper 4 and the housing edge or connection contour 14. The connection contour 14 forms a brake caliper-side opening of the filter housing 10. In circumferential direction CX, the filter housing 10 extends from the connection contour 14 or an open side of the housing 10 all the way to an end wall 16. The end wall 16 connects the outer sidewall 11A, the outer circumferential wall 12, and the inner sidewall 11B to each other. Between the inner circumferential wall sections 13A, 13B there is a ring-shaped slot 17 provided into which the brake disc 2 with its brake disc edge 2D can be introduced. The housing walls 11A, 11B, 12, 13A, 13B, 16 enclose a housing interior 20. The brake disc 2 penetrates into the housing interior 20, or the filter housing 10 encloses or surrounds a ring segment of the brake disc 2. The filter housing 10 or installed parts in the brake dust particle filter 1 do not contact the brake disc 2.

In FIG. 5, possible dimensions of the filter housing 10 are illustrated. FIG. 5 shows a side view from the exterior side of the disc brake assembly 100 in axial direction. One can see that the sidewalls, in particular the outer sidewall 11A visible in FIG. 5, has a ring segment shape. The filter housing 10, viewed from the axis of rotation A, is delimited radially inwardly by the inner circumferential wall sections 13A, 13B (not illustrated) and radially outwardly by the outer circumferential wall 12. In this context, an inner radius RI can result from the distance of the inner circumferential wall sections 13A, 13B and an outer radius RO from the distance of the circumferential wall 12 relative to the axis of rotation A. The difference of the radii RO-RI can be referred to as height H of the filter housing 10. The length of the filter housing 10 results from the extension along the circumference between the open side or the connection contour 14 facing the brake caliper 4 and the end wall 16. A width W of the filter housing 10 in its axial extension results from the distance between the two sidewalls 11A, 11B (compare FIGS. 4 and 6).

In operation of the disc brake assembly 100 and of the brake dust particle filter 1, an air flow in circumferential direction CX through the filter housing 10 along the rotation direction R of the brake disc 2 is produced by the rotation direction R of the brake disc 2.

In the interior 20 of the filter housing 10, the particles can deposit due to adhesion forces at the inner walls along the flow path in the filter housing 10 or (not shown here) can be bonded by suitable filter materials.

The filter housing 10 or the brake dust particle filter 1 can be fastened at the brake caliper holder by a suitable fastener means, for example, a screw. In FIGS. 3 and 6, one can see fastener means 19 in the form of a nut. In this context, the brake dust particle filter 1 can be fastened, either directly or indirectly with intermediate positioning of a holder/adapter, at the brake caliper holder 3.

The installation space in the region of the disc brake assembly 100, in particular in case of a steered front axle of a vehicle, can have an effect on the housing shape of the brake dust particle filter 1. For example, the filter housing 10 has axially inwardly a region 18 which is recessed in the direction toward the interior 20 of the filter housing 10 and arranged between the end wall 16 and the connection contour 14. Thus, a changing width of the cross section of the filter housing 10 results along the circumferential direction CX.

Based on FIGS. 7 to 12, different embodiments of the brake caliper support 6 will be described. All of the brake caliper supports 6 described with the aid of FIGS. 7 to 12 can be used in the disc brake assembly 100 of FIGS. 1 to 4.

FIG. 7 shows a lateral plan view of the disc brake assembly 100 according to FIG. 1 without brake dust particle filter 1. In the illustration of FIG. 7, one looks onto a first brake caliper support bracket 62 which, in plan view, has substantially a C-shape. The first brake caliper support bracket 62 comprises a connection section 63 as well as two lateral sections 65. The connection section 63 extends between two fastening sections 60, 61 that are embodied as axial holes and serve to attach the brake caliper support 6 to the steering knuckle of the vehicle.

The first brake caliper bracket 62 extends in the mounted state (FIG. 7) opposite the brake disc 2. As illustrated in FIG. 8, the connection section 63 extends substantially along the circumferential direction CX. The lateral sections 65 are positioned perpendicularly to the connection section 63 and extend substantially along the radial direction RX.

As illustrated in FIG. 8, the brake caliper support 6 comprises moreover a second brake caliper support bracket 66 that has a shape similar to the first brake caliper support bracket 62 but comprises no fastening sections 60, 61. In the mounted state, the brake disc 2 extends between the two brake caliper support brackets 62, 66.

The brake caliper support brackets 62, 66 are axially connected to each other at their lateral sections 65 by two brake caliper support bridges 64. They are positioned in the mounted state opposite the circumferential edge 2D of the brake disc 2. As illustrated in FIG. 7, the brake caliper support 6 engages around the brake disc 2 and frames the brake caliper 4 in doing so.

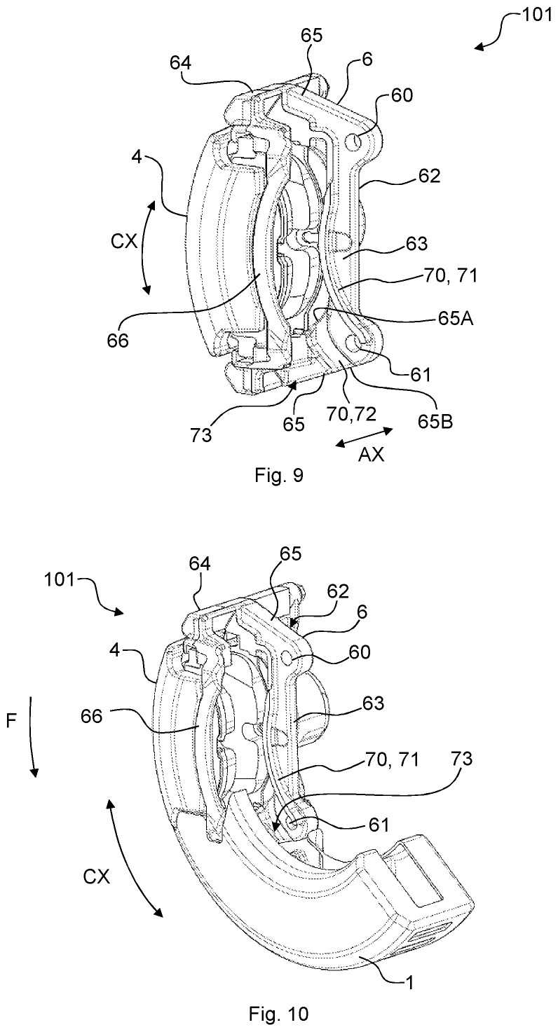

FIGS. 9 and 10 show a brake caliper device 101 with the brake caliper support 6 and the brake caliper 4 as well as the particle filter 1. As illustrated in FIGS. 9 and 10, the brake caliper support 6 comprises two air guiding elements 70 at an inner side of the brake caliper support 6, which is positioned opposite the brake disc 2 in the mounted state. Both air guiding elements 70 are formed as one piece together with the brake caliper support 6 and are provided at the first brake caliper support bracket 62.

The first air guiding element 70 is formed as a protrusion 71 (rib). It extends along the circumferential direction CX at the connection section 63. The protrusion 71 is arc-shaped. The protrusion 71 extends in this context in axial direction AX in the direction toward the brake disc 2. The protrusion 71 reduces a distance between the brake disc 2 and the brake caliper support 6 and prevents thus that the brake dust-laden air which circulates along the brake disc 2 exits radially from the brake caliper support 6. Moreover, the protrusion 71 is oriented such that it guides the air into the interior 20 of the brake dust particle filter 1 (see FIG. 10). The protrusion 71 guides the air in this context in the direction toward an exit region 73 which borders the brake dust particle filter 1. In this way, a degree of separation is increased.

The second air guiding element 70 is formed as a recess 72 (channel-shaped groove). It extends substantially along the circumferential direction CX at the lateral section 65 which is arranged at the side of the brake dust particle filter 1. As can be seen in FIG. 9, the recess 72 extends in circumferential direction CX continuously from an inner edge 65A of the lateral section 65 all the way to an outer edge 65B of the lateral section 65. The recess 72 is arc-shaped in this context. In the region of the recess 72, the lateral section 65 is recessed in axial direction AX away from the brake disc 2. The recess 72 increases a distance between the brake disc 2 and the brake caliper support 6 and forms thus a channel through which the particle-laden air is guided into the interior 20 of the brake dust particle filter 1 (see FIG. 10). The channel enlarges in this context the exit region 73. In this way, the degree of separation is increased.

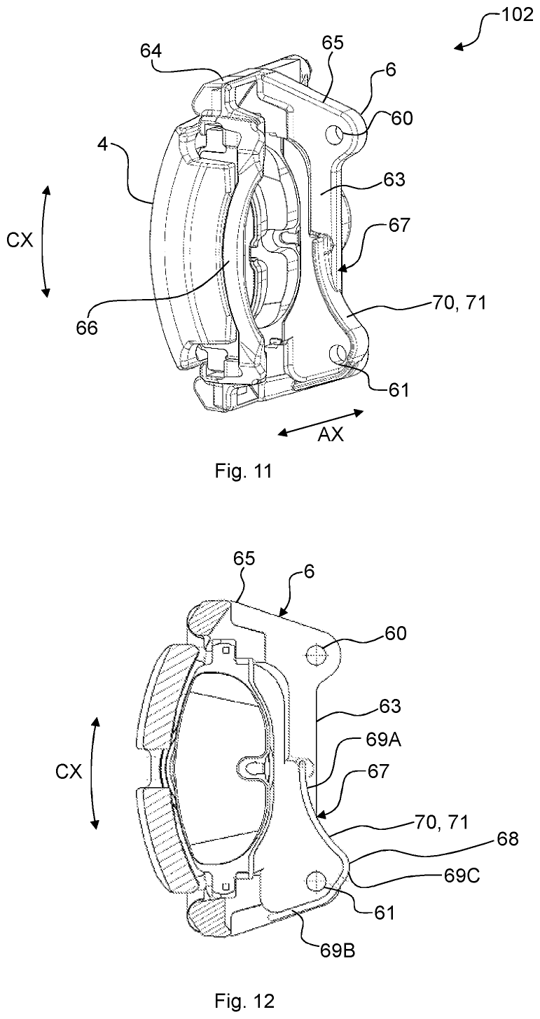

FIGS. 11 and 12 show a further brake caliper device 102 with a brake caliper support 6, the brake caliper 4, and the particle filter 1. As illustrated in FIGS. 11 and 12, the brake caliper support 6 comprises at its inner side an air guiding element 70. The air guiding element 70 is provided detachably at the first brake caliper support bracket 62.

The air guiding element 70 of FIGS. 11 and 12 is provided as a protrusion 71 and is fastened to an outer circumferential edge 67 of the connection section 63. The air guiding element 70 extends substantially along the outer edge 67. The air guiding element 70 comprises a first section 69A which extends in the mounted state tangentially and a second section 69B adjoining it and bent radially outwardly in the mounted state. The air guiding element 70 comprises a third section 69C between the first section 69A and the second section 69B which forms a radially inwardly oriented bulge or bend 68.

The air guiding element 70 deflects the air flowing about the brake disc 2 in particular in the direction of an intake region of an internal venting action of the brake disc 2. In this way, the particles in particular are not deflected into the environment but pass through the internal venting action of the brake disc 2 into the brake dust particle filter 1. Here, the particles can be separated at the filter medium due to the corresponding flow conditions.

The embodiments can be modified in many ways. It is e.g. conceivable to provide recesses 72 where the protrusions 71 are illustrated, and vice versa. In the example of FIGS. 9 and 10, the protrusion 71 and/or the recess 72 can be omitted. The geometry of the guiding elements 70 can be modified at will in order to optimize the air flow into the brake dust particle filter 1. Moreover, the shape of the brake caliper support 6 can be modified. It is e.g. conceivable to use a brake caliper support 6 that has only one brake caliper support bracket 62 and/or only one brake caliper support bridge 64 and/or only one lateral section 65.

### REFERENCE CHARACTERS

1 brake dust particle filter
2 brake disc
2A, 2B brake disc friction surface
2C outflow opening
2D brake disc edge
2E fastening plate
2F fastener opening
3 brake caliper holder
4 brake caliper
5 brake pad
6 brake caliper support
7 brake line connector
8 brake hydraulics
9 floating support
10 filter housing
11A (outer) sidewall
11B (inner) sidewall
12 (outer) circumferential wall section
13A (inner outwardly positioned) inner circumferential wall section
13B (inner inwardly positioned) inner circumferential wall section
14 connection contour
15 gap
16 end wall
17 slot
18 inwardly recessed housing region
19 filter fastener
20 housing interior
60, 61 fastening section
62 first brake caliper support bracket
63 connection section
64 brake caliper support bridge
65 lateral section
65A inner edge
65B outer edge
66 second brake caliper support bracket
67 circumferential edge
68 bend
69A first section
69B second section
69C third section
70 air guiding element
71 protrusion
72 recess
73 exit region
100 disc brake assembly
101 brake caliper device
102 brake caliper device
A axis of rotation
AX axial extension direction
CX circumferential extension direction
F forward travel direction
H height
R forward rotation direction
RI inner radius
RO outer radius
RX radial extension direction
W width

1. A brake caliper support for a brake caliper of a disc brake assembly comprising a brake disc, the brake caliper support comprising:
a first brake caliper support bracket comprising at least two fastening sections configured to connect the brake caliper support to a steering knuckle of a vehicle, wherein the first brake caliper support bracket is configured to be positioned opposite a brake disc friction surface of the brake disc of the disc brake assembly in a mounted state of the brake caliper support at the vehicle;
a brake caliper support bridge disposed at the first brake caliper support bracket and projecting away from the first brake caliper support bracket in an axial direction of the brake disc in the mounted state, wherein the brake caliper support bridge is configured to circumferentially surrounds the brake disc at least partially in the mounted state; and
an air guiding element which is arc-shaped and which is disposed at the first brake caliper support bracket, wherein the air guiding element is configured to be positioned axially opposite the brake disc friction surface of the brake disc in the mounted state,
wherein the air guiding element is a protrusion or a recess extending in the axial direction, respectively.

2. The brake caliper support according to claim 1, further comprising a second brake caliper support bracket positioned opposite the first brake caliper support bracket,
wherein the brake caliper support is configured to receive the brake disc between the first brake caliper support bracket and the second brake caliper support bracket in the mounted state, and
wherein the brake caliper support bridge connects the first brake caliper support bracket and the second brake caliper support bracket to each other.

3. The brake caliper support according to claim 1, wherein the first brake caliper support bracket comprises a connection section extending between the at least two fastening sections, and
wherein the first brake caliper support bracket further comprises a lateral section connecting the connection section to the brake caliper support bridge and extending with a radial direction component in relation to the axial direction in the mounted state.

4. The brake caliper support according to claim 3, wherein the air guiding element is arranged at the connection section and/or is arranged at the lateral section.

5. The brake caliper support according to claim 4, wherein the air guiding element extends along an extension direction of the connection section and/or extends along an extension direction of the lateral section.

6. The brake caliper support according to claim 4, wherein the air guiding element extends tangentially along an extension direction of the connection section and/or extends radially along an extension direction of the lateral section.

7. The brake caliper support according to claim 3, wherein the air guiding element comprises a rib, wherein the rib is arranged at the connection section and protrudes away from the connection section, or wherein the rib is arranged at the lateral section and protrudes away from the lateral section, or
wherein the air guiding element comprises a channel-shaped groove in the connection section or in the lateral section.

8. The brake caliper support according to claim 3, wherein the air guiding element is arranged at the connection section and comprises a protruding rib, and/or
wherein the air guiding element is arranged at the lateral section and comprises a channel-shaped groove.

9. The brake caliper support according to claim 1, wherein the first brake caliper support bracket has a surface,
wherein the air guiding element is a protrusion protruding away from the surface of the first brake caliper support bracket, or
wherein the air guiding element is a recess in the surface of the first brake caliper support bracket.

10. The brake caliper support according to claim 1, wherein the air guiding element is a protrusion arranged axially at a circumferential edge of the first brake caliper support bracket.

11. The brake caliper support according to claim 1, wherein the air guiding element is a protrusion and is detachably fastened to the first brake caliper support bracket.

12. The brake caliper support according to claim 11, wherein the protrusion is detachably fastened by a screw connection and/or by a clamping connection to the first brake caliper support bracket.

13. The brake caliper support according to claim 1, wherein the brake caliper support forms a one-piece configuration together with the air guiding element.

14. The brake caliper support according to claim 13, wherein the one-piece configuration is a single cast part.

15. The brake caliper support according to claim 1, wherein the first brake caliper support bracket comprises a connection section extending between the at least two fastening sections and further comprises a lateral section connecting the connection section to the brake caliper support bridge,
wherein the air guiding element extends as one piece along the connection section and along the lateral section, and wherein the air guiding element comprises a bend.

16. The brake caliper support according to claim 15, wherein the air guiding element comprises a first section extending tangentially in the mounted state and further comprises a directly or indirectly adjoining second section bent radially outwardly in the mounted state.

17. The brake caliper support according to claim 16, wherein the air guiding element comprises a third section arranged between the first section and the second section and forming a radially inwardly oriented bulge.

18. The brake caliper support according to claim 1, wherein the at least two fastening sections include a first fastening section and a second fastening section,
wherein the first brake caliper support bracket comprises a connection section extending between the first fastening and second fastening section, and
wherein the air guiding element extends continuously from the first fastening section to the second fastening section along the connection section.

19. The brake caliper support according to claim 1, wherein the first brake caliper support bracket comprises a connection section extending between the at least two fastening sections and further comprises a lateral section connecting the connection section to the brake caliper support bridge, wherein, in relation to the mounted state, the lateral section of the first brake caliper support bracket comprises an inner edge and an outer edge viewed in a circumferential direction of the brake disc, and
wherein the air guiding element extends continuously from the inner edge all the way to the outer edge.

20. A disc brake assembly comprising:
a brake caliper support according to claim 1; and
a brake disc comprising a brake disc friction surface arranged opposite the air guiding element of the brake caliper support and opposite the first brake caliper support bracket of the brake caliper support.

21. The disc brake assembly according to claim 20, wherein the air guiding element is configured to deflect brake dust-laden air flowing along the brake disc when the brake disc is rotating.

22. The disc brake assembly according to claim 20, wherein the air guiding element is configured to prevent a radial exit of the brake dust-laden air from the brake caliper support.

23. The disc brake assembly according to claim 20, wherein the first brake caliper support bracket comprises a connection section extending between the at least two fastening sections, and
wherein the air guiding element is arranged at the connection section of the first brake caliper support bracket and engages at least partially axially in a brake disc bell of the brake disc.

24. The disc brake assembly according to claim 20, further comprising a brake dust particle filter arranged downstream of the brake caliper support in a predetermined rotation direction of the brake disc.

25. A method of using the brake caliper support according to claim 1, the method comprising:
targeted guiding of brake dust-laden air flowing along a rotating brake disc by the air guiding element of the brake caliper support into a brake dust particle filter arranged in a predetermined rotation direction of the brake disc downstream of the brake caliper support.

26. A method for guiding brake dust-laden air flowing along a rotating brake disc, the method comprising:
deflecting the brake dust-laden air by the air guiding element of the brake caliper support according to claim 1; and
after deflecting, guiding the brake dust-laden air along a forward rotation direction of the brake disc so that the brake dust-laden air exits through an exit region from the brake caliper support, wherein the exit region is arranged downstream of a lateral section and/or of a connection section of the first brake caliper support bracket in a predetermined rotation direction of the brake disc.

27. The method according to claim 26, further comprising:
introducing the brake dust-laden air exiting from the exit region into a brake dust particle filter arranged downstream of the brake caliper support in the predetermined rotation direction of the brake disc.
